(19) United States
(12) Patent Application Publication
(10) Pub. No.: US 2020/0369454 A1
(43) Pub. Date: Nov. 26, 2020

(54) CONTAINER AND METHOD FOR RECONSTITUTION OF SUBSTANCES

(71) Applicant: Unipharma, LLC, Tamarac, FL (US)

(72) Inventor: Raimundo Jose Santamarta, Aventura, FL (US)

(73) Assignee: Unipharma, LLC, Tamarac, FL (US)

(21) Appl. No.: 16/767,639

(22) PCT Filed: Dec. 6, 2018
(86) PCT No.: PCT/US18/64179

§ 371 Date: May 28, 2020

Related U.S. Application Data
(60) Provisional application No. 62/596,723, filed on Dec. 8, 2017.

(51) Int. Cl. B65D 81/32; B65D 85/804; B01F 1/00; B01F 13/00

(52) U.S. Cl. CPC B65D 81/3211; B65D 85/804; B01F 1/0022; B01F 2215/0032; B65D 2217/00; B01F 2215/0022; B01F 13/0022

(57) ABSTRACT

A method for reconstitution of substances includes a liquid container having a pre-determined volume of diluent and a powder container having a corresponding pre-determined amount of powder to be reconstituted. The method allows an individual to safely reconstitute the powder into a liquid solution having the desired concentration without measuring or potential spillage. The powder container includes a female threaded connection designed for liquid-tight attachment to the liquid container and further includes a breakable membrane seal which, when broken by the distal end of the liquid container, creates an orifice for the diluent to enter the powder container to reconstitute the powder and thereafter be displaced into the liquid container for use. Before the membrane seal is broken, the pre-determined amount of powder partially occupies the powder container chamber.

### CROSS REFERENCE TO RELATED APPLICATION

This application claims benefit of U.S. Provisional Application No. 62/596,723, filed Dec. 8, 2017, the contents of which are hereby incorporated by reference in their entirety for all purposes.

### TECHNICAL FIELD

This invention relates to reconstitution of substances.

### BACKGROUND ART

Historically, dietary supplements or pharmaceutical powders have been reconstituted with a diluent for oral delivery.

Reconstitution has many advantages over pre-mixed solutions. Because powder can be stored in an anhydrous state, potency of the active ingredients degrade slower and have an increased shelf life. A powder logistically is easier to manufacture and results in a lower manufacturing cost when compared to other dosage forms. The reconstituted solution is believed to have a higher efficacy for facilitating rapid absorption by the body when compared to the alternative of prolonged storage of a liquid dose form.

However, reconstitution of solutions can be problematic if attempted by an individual. These include inaccurate dosage mixing i.e. mixing the powder with excessive or insufficient diluent; or, spillage of either powder or diluent. The mixing procedure itself may be volatile, hygroscopic and oxidizable.

Techniques have been developed utilizing plastic for manufacture and filling of liquid solutions for storage. For example, Polyethylene Terephthalate (PET) can be utilized in a stretch blow molding process to create a container. A separate cover is also created, usually by the same process; the container is filled with the desired solution and the cover is threadably attached. Typically, a tamper-proof seal is thereafter applied to the container-cover interface to ensure the interior solution will not become contaminated.

Another technique utilizes blow-fill seal (BFS) technology which refers to the manufacturing technique used to produce various sized liquid filled plastic containers ranging from as small as 0.1 mL to over 500 mL. Originally developed in Europe in the 1930s, it was introduced in the United States in the 1960s, but over the last 20 years it has become more prevalent within the pharmaceutical industry, and it is now widely considered to be the superior form of aseptic processing by various medicine regulatory agencies including the U.S. Food and Drug Administration (FDA) in the packaging of pharmaceutical and healthcare products.

The basic concept of BFS is that a container is formed, filled, and sealed in a continuous process without human intervention, in a sterile enclosed area inside a machine. Thus, this technology can be used to aseptically manufacture sterile pharmaceutical liquid dosage forms with a removable cap. This avoids additional manufacturing costs associated with application of a tamper-proof seal.

However, a need exists for an individual to reconstitute powders into a usable solution while avoiding the problems discussed above.

### SUMMARY OF THE INVENTION

A method for reconstituting a substance, typically in powder form, using an appropriate diluent is disclosed. Reconstitution occurs in a closed environment where measuring and spillage of components is eliminated thereby ensuring a correct liquid solution concentration can be consistently obtained. A primary area of use would be in the field of reconstitution of medicinal powders. As used herein, the term “powder” will refer to the standard dictionary definition of the term but will also include other similar substances such as “granule” or other substances susceptible to reconstitution with an appropriate liquid.

The method requires two separate containers; a liquid container for containing the diluent and a powder container containing the powder for reconstitution. Each container has a predetermined amount of substance to be mixed together to obtain the desired concentration for the reconstituted liquid solution. The amount of diluent for the liquid container is typically measured by volume and the amount of powder for the powder container is typically measured by weight although any suitable measurement can be utilized to describe the desired amount of substance in each container.

In one embodiment, each container can be manufactured preferably using blow-fill seal technology to insure both powder and diluent are aseptic. Both powder and diluent can be hermitically sealed using this technology.

In a second embodiment, either powder or liquid container can be manufactured using a process other than blow-fill seal technology. However, using a non BFS technology to manufacture will typically require additional tamper-proof packaging.

Both containers are designed for temporary attachment to one another so that the pre-determined volume of diluent can be displaced into the powder container and solubilize the pre-determined amount of powder, creating a liquid solution which is thereafter displaced into the liquid container for immediate use or for temporary storage.

The liquid container comprises a container body and a neck portion having at its distal tip an opening sufficient for liquid to pass when the container body is squeezed. Typically, this opening is a small diameter suitable for dispensing the liquid in droplet form. However, the opening can be larger, depending on the magnitude of components to be reconstituted.

The liquid container is to be attached to the powder container for liquid transfer. Therefore, the attachment is required to be liquid-tight. Preferably, male threads are present about the neck portion for engagement with corresponding female threads located on the powder container as discussed later. However, other forms of attachment common in the prior art can be used to provide a liquid-tight seal such as a Luer Lock.

The liquid container is made of a suitable plastic material having deformable and resilient characteristics which permit the liquid container to be squeezed (i.e. to inwardly deform the container thus reducing the inner space in response to a suitable force applied by for example, an individual's thumb and forefinger to opposite sides). Preferably, the plastic used would be PET, low density polyethylene, polypropylene, or copolymer blends thereof. For descriptive purposes, the liquid container could be either made using stretch blow molding having a threadable cap and tamper proof seal similar to a plastic eye-drop container, or, most preferably, it could be made using BFS technology, in which case no tamper proof seal is required. However, a liquid container made using BFS technology would include a separate threadable cap for use after displacement of the liquid solution into the liquid container for covering the tip opening.

The powder container body includes a female cavity and an internal volume referred to hereafter as a chamber. A portion of the chamber is occupied by the pre-determined amount of powder. A portion of the powder container body located adjacent to the female cavity has a reduced wall thickness relative to the other portions of the body and defines a breakable membrane seal. The chamber is air-tight thereby minimizing oxidation of the powder within. The chamber is of a size to include the powder, the volume of diluent necessary to reconstitute the powder, and sufficient space for the substances to be swirled, mixed or agitated to ensure complete reconstitution. Preferably, the powder occupies no more than about 25% of the chamber volume. The powder container is preferably made of a transparent thermoplastic body so that mixing within the chamber can be viewed to determine when the powder is fully reconstituted. Extending away from the membrane seal and chamber is a cylindrical wall that defines an inner female cavity suitably sized to mate with the neck portion of the liquid container. Preferably, the cavity includes female threads to threadably engage the male threads of the liquid container although other forms of attachment common in the prior art can be used to provide a liquid-tight seal between the liquid container and powder container. Preferably, the cavity is covered to maintain a sterile condition using a covering or sealed packaging around the container. Most preferably, at the distal end of the cylindrical wall is a removable adhesive strip covering the cavity for maintaining a sterile condition until removed.

In one embodiment, a second, outer concentric cylindrical wall is provided along with one or more radial supports connected to both walls for structural stabilization of the inner cylindrical wall.

Having described the containers, the method for reconstituting the powder is as follows:

a) Removing any adhesive seals or protective packaging from about the containers.

b) Attaching the liquid container having a pre-determined amount of diluent to the powder container having a pre-determined amount of powder by inserting the neck of the liquid container into the cavity of the powder container. As the containers are attached to one another, the distal tip of the liquid container comes into contact with and breaks the membrane seal creating an orifice for diluent to be displaced from the liquid container into the powder container. The connection between the containers becomes a seal preventing the leakage or spillage of diluent and reconstituted solution.

c) Displacing the diluent from the liquid container into the powder container.

d) Moving both containers in a motion to shake or swirl the contents in the powder container until the powder is completely reconstituted into a liquid solution.

e) Displacing the liquid solution into the liquid container.

f) Detaching the liquid container from the powder container.

The liquid container now contains the liquid solution for application. The powder container is discarded.

Although the orifice is created once both containers are attached to one another, it is preferable that the orifice is sufficiently limited in diameter to prevent the powder contents from being discharged while in powder form. An orifice of limited diameter would prevent powder spillage were the containers to be disconnected prior to diluent entry into the powder container.

Unless the liquid container is immediately used, a cap or cover is provided to prevent contamination.

Many modifications and other embodiments of the inventions set forth herein will come to mind to one skilled in the art. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### DESCRIPTION OF THE DRAWINGS

FIG. 1 illustrates one embodiment of a powder container and liquid container for reconstituting substances described herein;

FIG. 2 illustrates the peeling away of a removable adhesive strip and insertion of the liquid container for threadable engagement;

FIG. 3 illustrates diluent displaced into the powder container;

FIG. 4 is illustrates motion of the containers to reconstitute the powder;

FIG. 5 illustrates force applied for the reconstituted solution being displaced into the liquid container;

FIG. 6 illustrates force removed for the reconstituted solution being displaced into the liquid container; and,

FIG. 7 is the liquid container containing the reconstituted solution.

FIG. 8 is an alternate embodiment for the powder container.

FIG. 9 is a view taken along line 9-9 of FIG. 8.

### BEST MODE FOR CARRYING OUT THE INVENTION

The figures provided herein are not necessarily drawn to scale and are provided for representational and instructional purposes.

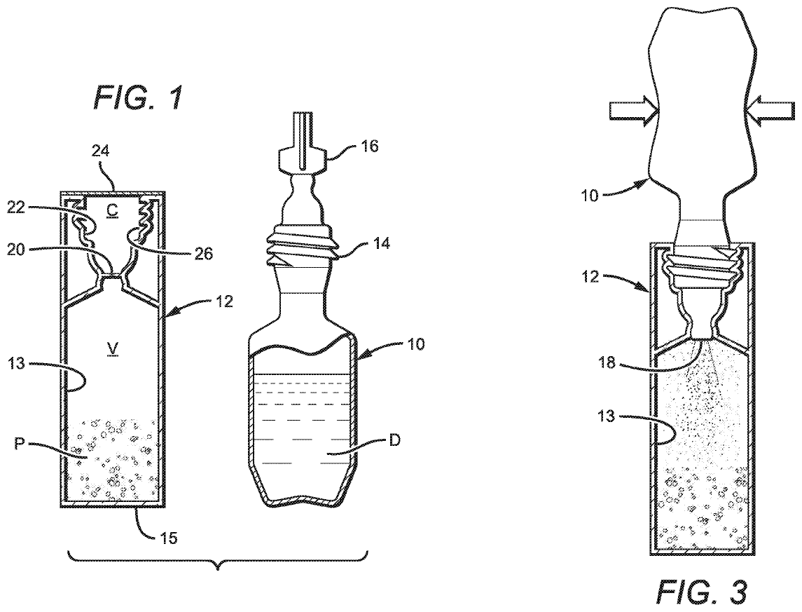

FIG. 1 illustrates the two separate containers 10 and 12 which are used to reconstitute a substance. Powder container 12 has a predetermined amount of powder P for reconstitution into a liquid solution S. Liquid container 10 has a predetermined volume of diluent D to reconstitute powder P into solution S having the desired concentration.

Liquid container 10 is constructed using BFS technology and has a threaded neck 14 with male threads and a twist-off closure 16 which when removed, exposes the distal tip 18 that has an opening sufficient for liquid to pass as shown in FIG. 3. Liquid container 10 is made of a deformable but resilient plastic material which permits an individual (not shown) to squeeze the container to inwardly deform using a suitable force applied by thumb and forefinger as represented by the FIG. 3 arrows. Preferably, the plastic used would be PET, low density polyethylene, polypropylene, or copolymer blends thereof. A threadable cap 28 is provided for use following reconstitution as shown in FIG. 7.

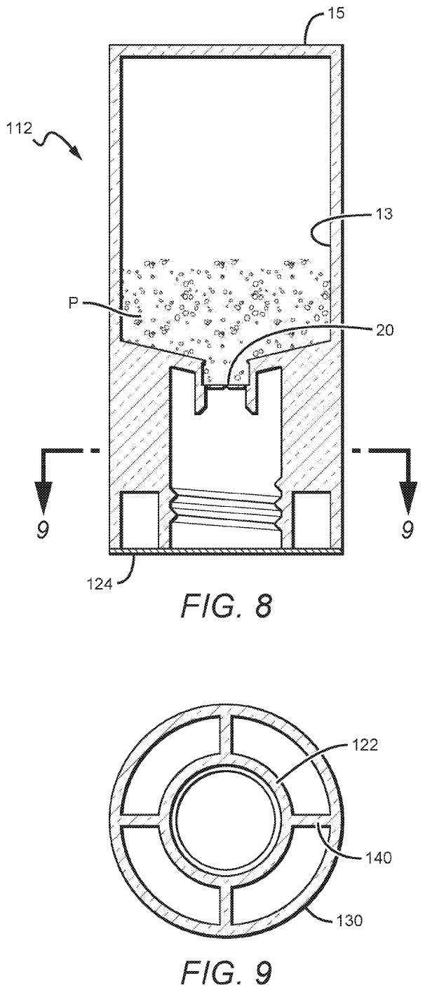

Powder container 12 is constructed from a stretch blow molding process and is transparent. Powder container 12 includes a chamber 13 and a breakable membrane seal 20. During manufacture, base 15 is made separately from the remaining body. Once the pre-determined amount of powder P is deposited into volume V, base 15 is thereafter permanently affixed creating an air-tight seal within chamber 13. The only entry or exit from chamber 13 will be created once membrane seal 20 is broken. Membrane seal 20 has a reduced wall thickness relative to the adjacent portions of powder container 12 so that it will fail upon a sufficient force applied by tip 18 of liquid container 10 as will be discussed below. When membrane seal 20 is broken, an orifice is created for diluent entry from liquid container 10 into chamber 13 and reconstituted liquid from chamber 13 into liquid container 10. Powder container 12 also includes a general shaped cylindrical wall 22 having an inside diameter at least the diameter of the orifice. Wall 22 is located on the side of breakable membrane seal 20 opposite chamber 13. Cylindrical wall 22 includes female threading 26 for engagement with the male threads on liquid container 10. The space between cylindrical wall 22 defines a cavity C. In an alternate embodiment illustrated in FIGS. 8 and 9, powder container 112 further includes an outer cylindrical wall 130, concentric with cylindrical wall 122 also extends away from chamber 13. A plurality of supports 140 extend radially, integral with walls 122 and 130. Outer cylindrical wall 130 is an integral extension of the cylindrical wall surrounding chamber 13.

Referring to the embodiment shown in FIG. 1, at the distal end of cylindrical wall 22 is a removable adhesive strip 24 which covers cavity C until powder container 112 is ready for use. Referring to the embodiment shown in FIG. 8, at the distal end of cylindrical wall 122 is a removable strip 124 which covers cavity C and the annular region between walls 122 and 130 until powder container 112 is ready for use.

Each powder container can be designed in various sizes, from micro (0.01-2 gr), medium (2-5 gr) and larger doses (above 5 gr). The size of the container can be defined as the weight of the substance to be reconstituted.

Having described the containers, to reconstitute the powder P, an individual (not shown) performs the following to steps.

Remove twist-off closure 16 from liquid container 10.

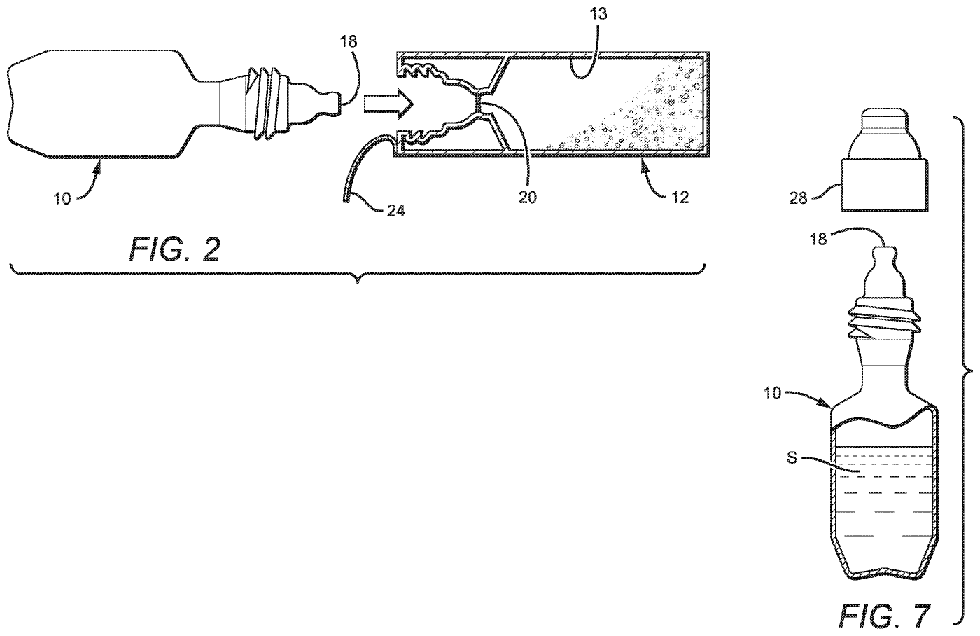

Remove adhesive strip 24 from powder container 12 illustrated in FIG. 2.

Threadably attach liquid container 10 to powder container 12 until distal tip 18 of neck 14 breaks membrane seal 20 creating an orifice through which diluent D can enter chamber 13.

The body of liquid container 10 is squeezed to expel diluent D through the orifice into chamber 13 as shown in FIG. 3. The threaded connection between both containers becomes a seal preventing leakage of diluent D. Liquid container 10 is positioned vertically above powder container 12 for gravity to assist in displacement of diluent D.

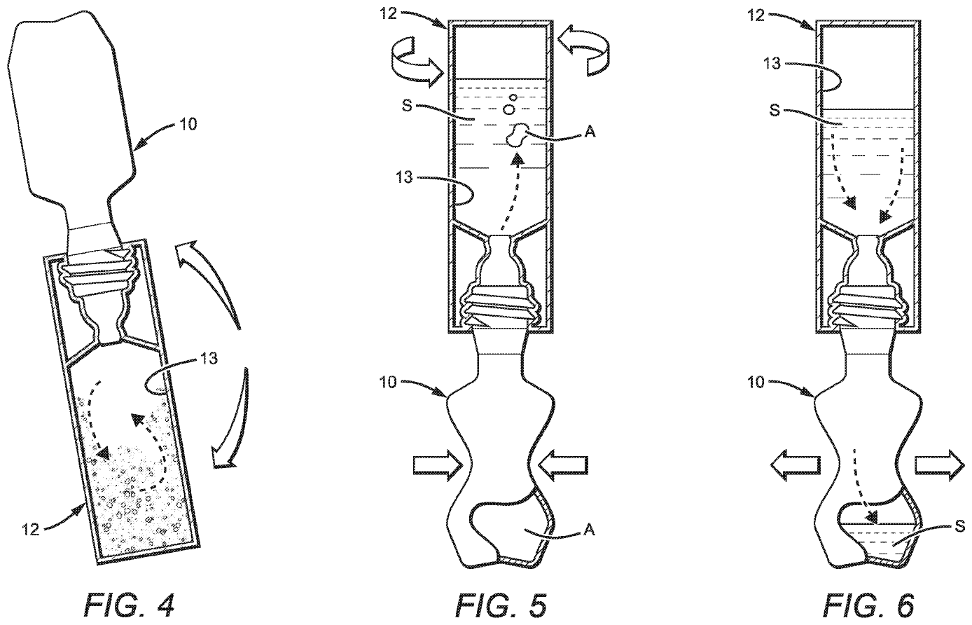

Once diluent D has been displaced into the powder container 12, both containers are moved in such a manner to cause the contents within chamber 13 to be shaken or swirled as represented by the arrows in FIG. 4 until the powder is reconstituted into liquid solution S.

Liquid solution S is then displaced into liquid container 10 by inverting the containers so that gravity can assist in displacement as well as the body of liquid container 10 being intermittently squeezed, represented by the facing pair of arrows; and, in a motion to swirl the contents within powder container 12 as represented by the circular pair of arrows depicted in FIG. 5. This movement assists in displacing air A from liquid container 10 into powder container 12. FIG. 6 illustrates the resiliency of liquid container 10 where expansion to its original form assists liquid solution S to flow therein when the container is not squeezed as represented by the opposite direction pair of arrows.

Once the reconstituted liquid solution S has been displaced into liquid container 10, powder container 12 is detached from liquid container 10 and discarded.

Reconstituted liquid solution S can then be used immediately or stored within liquid container 10 for subsequent use by threadably attaching cap 28.

I claim:

1. (canceled)

2. (canceled)

3. A disposable container for reconstituting a powder into a liquid, the container comprising:
a chamber having partially disposed within a pre-determined weight of a powder for reconstitution;
a breakable membrane seal which when broken by tip of a separate liquid container, creates an orifice for diluent entry from a separate liquid container into the chamber and reconstituted liquid from the chamber into the separate liquid container;
a cylindrical wall located on the side of the breakable membrane seal opposite the chamber, the cylindrical wall having female threads and the interior space surrounding the cylindrical wall defining a cavity;
an outer cylindrical wall, concentric with said cylindrical wall and further having at least one radial support integrally connected to both walls; and,
a removable adhesive seal covering the cavity.

4. (canceled)

5. The disposable container of claim 3 further comprising a protective adhesive film covering the distal circumference of the cylindrical wall.

6. (canceled)

7. The disposable container of claim 3 where said container is made of a transparent plastic material.

8. The disposable container of claim 3 where said pre-determined weight of powder occupies up to about 25% of the chamber.

9. A container comprising:
a transparent thermoplastic body having a chamber and within said chamber is a pre-determined weight of a powder for reconstitution that occupies up to about 25% of the chamber;
a portion of the thermoplastic body having a reduced wall thickness relative to the other portions of the body that defines a breakable membrane seal which when broken by tip of a separate liquid container, creates an orifice for diluent entry from a separate liquid container into the chamber and reconstituted liquid from the chamber into the separate liquid container;
a cylindrical wall located on the side of the breakable membrane seal opposite the chamber, the cylindrical wall having female threads and the interior space surrounding the cylindrical wall defining a cavity;
an outer cylindrical wall, concentric with said cylindrical wall and further having at least one radial support integrally connected to both walls; and,
a removable adhesive seal covering the cavity.

10. The container of claim 9 where the orifice is sufficiently limited in diameter to prevent discharge of the pre-determined amount of powder while in powder form.
